(19) United States
(12) Patent Application Publication
(10) Pub. No.: US 2011/0194822 A1
(43) Pub. Date: Aug. 11, 2011

(54) CABLE ASSEMBLY HAVING FLOATABLE OPTICAL MODULE

(75) Inventors: TOD M. HARLAN, Mechanicsburg, PA (US); TERRANCE F. LITTLE, York, PA (US)

(73) Assignee: HON HAI PRECISION INDUSTRY CO., LTD., Tu-Cheng (TW)

(21) Appl. No.: 12/701,619

(22) Filed: Feb. 8, 2010

(51) Int. Cl. G02B 6/36

(52) U.S. Cl. 385/92

(57) ABSTRACT

A cable assembly (100) includes an insulative housing (2) defining a mounting cavity (221); an optical module (5) accommodated in the mounting cavity and capable of moving therein along a front-to-back direction; at least one fiber (6) coupled to the optical module; and a one-piece resilient member (91) disposed in the mounting cavity and arranged behind the optical module, the resilient member (91) having a left resilient portion (911A) and a right resilient portion (911B) spaced apart from each other along a transversal direction to bias the optical module.

### CROSS-REFERENCE TO RELATED APPLICATIONS

This application is related to U.S. patent application Ser. No. 11/818,100, filed on Jun. 13, 2007 and entitled “EXTENSION TO UNIVERSAL SERIAL BUS CONNECTOR WITH IMPROVED CONTACT ARRANGEMENT”, and U.S. patent application Ser. No. 11/982,660, filed on Nov. 2, 2007 and entitled “EXTENSION TO ELECTRICAL CONNECTOR WITH IMPROVED CONTACT ARRANGEMENT AND METHOD OF ASSEMBLING THE SAME”, and U.S. patent application Ser. No. 11/985,676, filed on Nov. 16, 2007 and entitled “ELECTRICAL CONNECTOR WITH IMPROVED WIRE TERMINATION”, and U.S. patent application Ser. No. 12/626,632 filed on Nov. 26, 2009 and entitled “CABLE ASSEMBLY HAVING POSITIONING MEANS SECURING FIBER THEREOF”, and U.S. patent application Ser. No. 12/626,631 filed Nov. 26, 2009 and entitled “CABLE ASSEMBLY HAVING POSITIONING MEANS SECURING FIBER THEREOF”, and U.S. patent application Ser. No. 12/647,412 filed Dec. 25, 2009 and entitled “CABLE ASSEMBLY HAVING FLOATABLE OPTICAL MODULE”, and U.S. patent application Ser. No. 12/636,775 filed Dec. 13, 2009 and entitled “CABLE ASSEMBLY HAVING FLOATABLE OPTICAL MODULE”, and U.S. patent application Ser. No. 12/647,411 filed Dec. 25, 2009 and entitled “CABLE ASSEMBLY HAVING FLOATABLE OPTICAL MODULE”, all of which have the same assignee as the present invention.

### BACKGROUND OF THE INVENTION

1. Field of the Invention

The present invention relates to a cable assembly, more particularly to a cable assembly capable of transmitting optical signal.

2. Description of Related Art

Recently, personal computers (PC) are used of a variety of techniques for providing input and output. Universal Serial Bus (USB) is a serial bus standard to the PC architecture with a focus on computer telephony interface, consumer and productivity applications. The design of USB is standardized by the USB Implementers Forum (USB-IF), an industry standard body incorporating leading companies from the computer and electronic industries. USB can connect peripherals such as mouse devices, keyboards, PDAs, gamepads and joysticks, scanners, digital cameras, printers, external storage, networking components, etc. For many devices such as scanners and digital cameras, USB has become the standard connection method.

USB supports three data rates: 1) A Low Speed rate of up to 1.5 Mbit/s (187.5 KB/s) that is mostly used for Human Interface Devices (HID) such as keyboards, mice, and joysticks; 2) A Full Speed rate of up to 12 Mbit/s (1.5 MB/s). Full Speed was the fastest rate before the USB 2.0 specification and many devices fall back to Full Speed. Full Speed devices divide the USB bandwidth between them in a first-come first-served basis and it is not uncommon to run out of bandwidth with several isochronous devices. All USB Hubs support Full Speed; 3) A Hi-Speed rate of up to 480 Mbit/s (60 MB/s). Though Hi-Speed devices are advertised as “up to 480 Mbit/s”, not all USB 2.0 devices are Hi-Speed. Hi-Speed devices typically only operate at half of the full theoretical (60 MB/s) data throughput rate. Most Hi-Speed USB devices typically operate at much slower speeds, often about 3 MB/s overall, sometimes up to 10-20 MB/s. A data transmission rate at 20 MB/s is sufficient for some but not all applications. However, under a circumstance transmitting an audio or video file, which is always up to hundreds MB, even to 1 or 2 GB, currently transmission rate of USB is not sufficient. As a consequence, faster serial-bus interfaces are being introduced to address different requirements. PCI Express, at 2.5 GB/s, and SATA, at 1.5 GB/s and 3.0 GB/s, are two examples of High-Speed serial bus interfaces.

From an electrical standpoint, the higher data transfer rates of the non-USB protocols discussed above are highly desirable for certain applications. However, these non-USB protocols are not used as broadly as USB protocols. Many portable devices are equipped with USB connectors other than these non-USB connectors. One important reason is that these non-USB connectors contain a greater number of signal pins than an existing USB connector and are physically larger as well. For example, while the PCI Express is useful for its higher possible data rates, a 26-pin connector and wider card-like form factor limit the use of Express Cards. For another example, SATA uses two connectors, one 7-pin connector for signals and another 15-pin connector for power. In essence, SATA is more useful for internal storage expansion than for external peripherals.

The existing USB connectors have a small size but low transmission rate, while other non-USB connectors (PCI Express, SATA, et al) have a high transmission rate but large size. Neither of them is desirable to implement modern high-speed, miniaturized electronic devices and peripherals. To provide a connector with a small size and a high transmission rate for portability and high data transmitting efficiency is much more desirable.

In recent years, more and more electronic devices are adopted for optical data transmission. It may be a good idea to design a connector which is capable of transmitting an electrical signal and an optical signal. Design concepts are already common for such a type of connector which is compatible of electrical and optical signal transmission. The connector includes metallic contacts assembled to an insulated housing and several optical lenses bundled together and mounted to the housing also. A kind of hybrid cable includes wires and optical fibers that are respectively attached to the metallic contacts and the optical lenses.

However, optical lenses are unable to be floatable with regard to the housing. They are not accurately aligned with, and optically coupled to counterparts, if there are some errors in manufacturing process.

### BRIEF SUMMARY OF THE INVENTION

Accordingly, an object of the present invention is to provide a cable assembly having a floatable optical module.

In order to achieve the above-mentioned object, a cable assembly in accordance with present invention is comprised of: an insulative housing defining a mounting cavity; an optical module accommodated in the mounting cavity and capable of moving therein along a front-to-back direction; at least one fiber coupled to the optical module; and a one-piece resilient member disposed in the mounting cavity and arranged behind the optical module, the resilient member having a left resilient portion and a right resilient portion spaced apart from each other along a transversal direction to bias the optical module.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of a cable assembly in accordance with the first embodiment of the present invention;

FIG. 2 is an exploded, perspective view of FIG. 1;

FIG. 3 is similar to FIG. 2, but viewed from another aspect;

FIG. 4 is a partially assembled view of the cable assembly;

FIG. 5 is other partially assembly view of the cable assembly;

FIG. 6 is an exploded, perspective view of a cable assembly in accordance with the second embodiment of the present invention;

FIG. 7 is similar to FIG. 6, but viewed from another aspect;

FIG. 8 is a partially assembled view of the cable assembly of FIG. 6;

FIG. 9 is other partially assembly view of the cable assembly of FIG. 6;

FIG. 10 is an assembled, perspective view of a cable assembly in accordance with the third embodiment of the present invention;

FIG. 11 is an interior structure of the cable assembly in FIG. 10, with a metal shell outside removed away;

FIG. 12 is a partially exploded view of FIG. 11;

FIG. 13 is an exploded view of FIG. 11;

FIG. 14 is similar to FIG. 13, but viewed from other aspect;

FIG. 15 is an interior structure of the cable assembly in accordance with the fourth embodiment of the present invention;

FIG. 16 is a partially exploded view of FIG. 15;

FIG. 17 is an exploded view of FIG. 15;

FIG. 18 is similar to FIG. 17, but viewed from other aspect;

FIG. 19 is an assembled, perspective view of a cable assembly in accordance with the fifth embodiment of the present invention;

FIG. 20 is an exploded, perspective view of FIG. 19;

FIG. 21 is similar to FIG. 20, but viewed from another aspect;

FIG. 22 is a partially assembled view of the cable assembly;

FIG. 23 is other partially assembled view of the cable assembly;

FIG. 24 is an enlarged view of an insulative housing;

FIG. 25 is an enlarged view of the insulative housing, with two resilient members mounted thereto; and

FIG. 26 illustrates the two resilient members being deflected when an optical module is pushed rearwardly.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details.

Reference will be made to the drawing figures to describe the present invention in detail, wherein depicted elements are not necessarily shown to scale and wherein like or similar elements are designated by same or similar reference numeral through the several views and same or similar terminology.

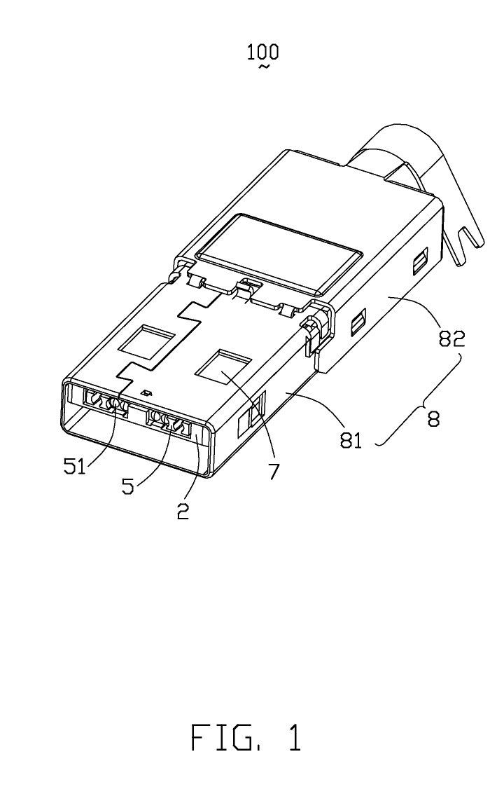

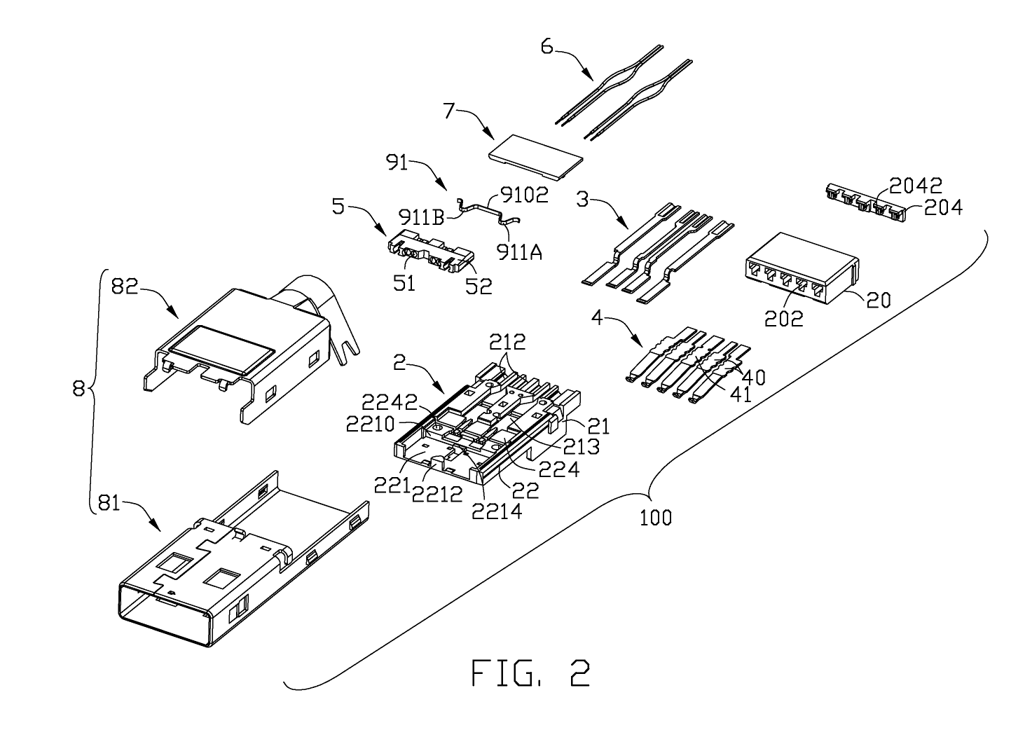

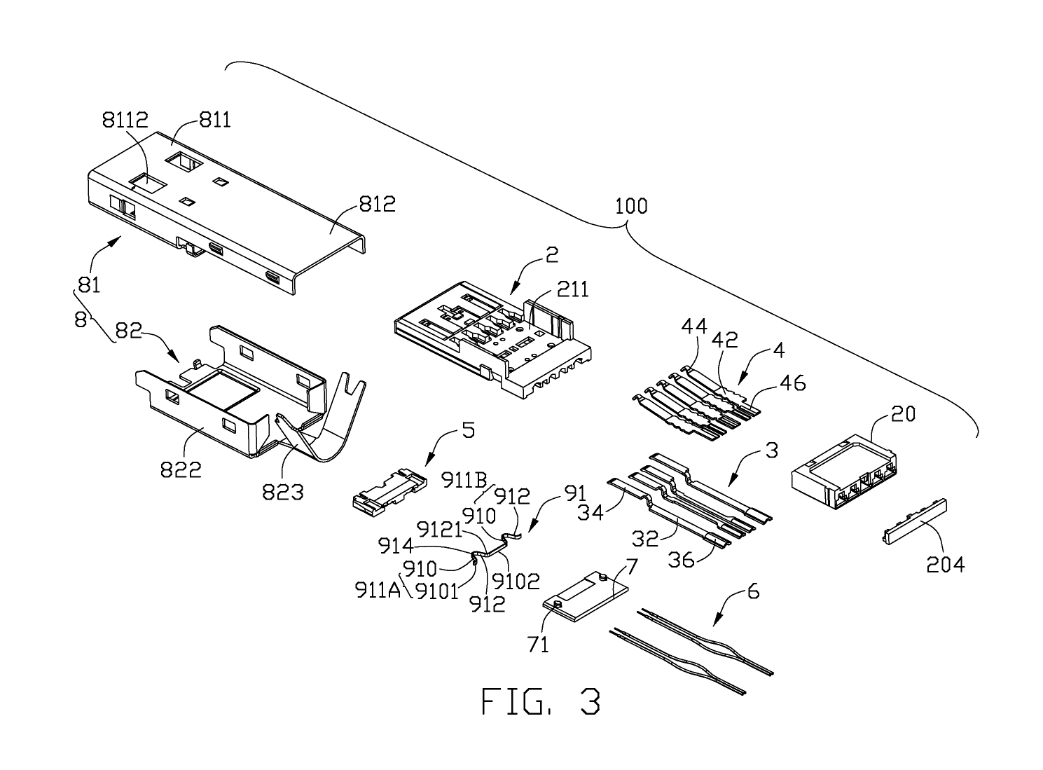

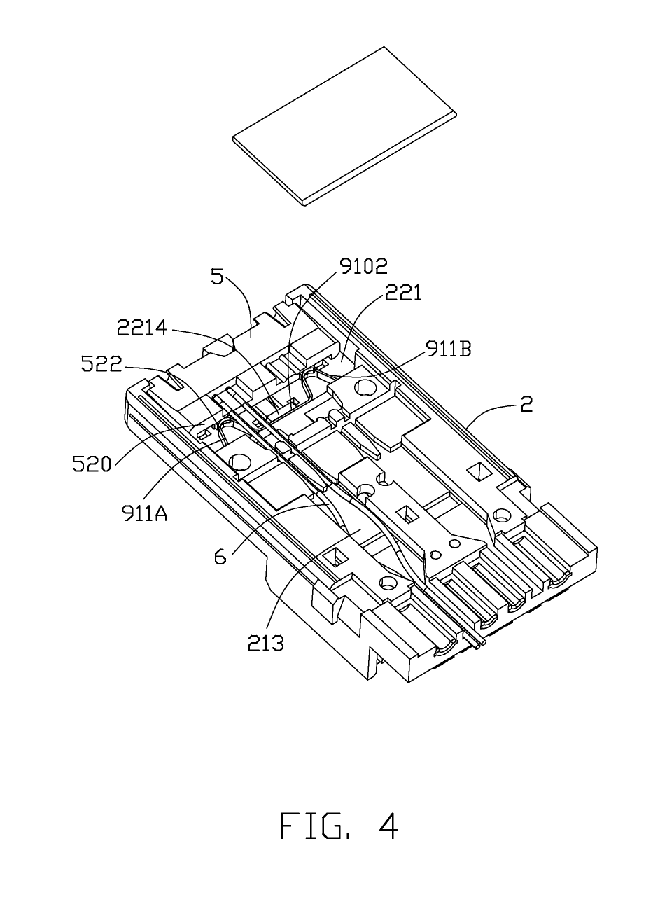

Referring to FIGS. 1-5, a cable assembly 100 in accordance with the first embodiment of the present invention is disclosed. The cable assembly 100 comprises an elongated insulative housing 2 extending along a front-to-back direction, a set of first contacts 3, a set of second contacts 4 and an optical modules 5 supported by the insulative housing 2, and a number of fibers 6 coupled to the optical module 5. The cable assembly 1 further comprises a cap member 7, a metal shell 8 and a resilient member 91. The resilient member 91 is capable of biasing the optical modular 5 along the front-to-back direction. Detail description of these elements and their relationship and other elements formed thereon will be detailed below.

The insulative housing 2 includes a base portion 21 and a tongue portion 22 extending forwardly from the base portion 21. A cavity 211 is recessed upwardly from a bottom surface (not numbered) of the base portion 21. A mounting cavity 221 is recessed downwardly from a top surface of the tongue portion 22. A stopping member 2212 is formed in a front portion of the mounting cavity 221. In addition, a protrusion 2214 is located in a back portion of the mounting cavity 221 and arranged proximate to a back side 2210 of the mounting cavity 221. The protrusion 2214 and the stopping member 2212 are aligned with each other along the front-to-back direction and arranged in a middle section of the mounting cavity 221. A depression 224 is defined in a rear portion of the tongue portion 22 and communicating with the mounting cavity 221. A number of contact slots 212 are defined in an upper segment of a rear portion of the base portion 21. Two fiber grooves 213 are defined in the base portion 21 and extend along the front-to-back direction, pass the depression 224 and communicate with the mounting cavity 221.

The set of first contacts 3 have four contact members arranged in a row along the transversal direction. Each first contact 3 substantially includes a planar retention portion 32 supported by a bottom surface of the cavity 211, a mating portion 34 raised upwardly and extending forwardly from the retention portion 32 and disposed in a depressed area 226 of the lower section of the front segment of the tongue portion 22, and a tail portion 36 extending rearward from the retention portion 32 and accommodated in the terminal slots 212.

The set of second contacts 4 have five contact members arranged in a row along the transversal direction and combined with an insulator 20. The set of second contacts 4 are separated into two pairs of signal contacts 40 for transmitting differential signals and a grounding contact 41 disposed between the two pair of signal contacts 40. Each second contact 4 includes a planar retention portion 42 received in corresponding groove 202 in the insulator 20, a curved mating portion 44 extending forward from the retention portion 42 and disposed beyond a front surface of the insulator 20, and a tail portion 46 extending rearward from the retention portion 42 and disposed behind a back surface of the insulator 20. A spacer 204 is assembled to the insulator 20, with a number of ribs 2042 thereof inserted into the grooves 202 to position the second contacts 4 in the insulator 20.

The insulator 20 is mounted to the cavity 211 of the base portion 21 and press onto retention portions 32 of the first contacts 3, with mating portions 44 of the second contacts 4 located behind the mating portions 34 of the first contacts 3 and above the up surface of the tongue portion 22, the tail portions 46 of the second contacts 4 arranged on a bottom surface of the rear segment of the base portion 21 and disposed lower than the tail portions 36 of the first contacts 3.

The optical module 5 includes four lens members 51 arranged in juxtaposed manner and enclosed by a holder member 52 and retained in the mounting cavity 221.

The resilient member 91 is configured as a one-piece type structure and includes two substantially bell shaped (tapered contour along a front-to-back direction) resilient portions which includes a left resilient portion 911A and a right resilient portion 911B spaced apart from each other and interconnected together by a transversal beam 9102. Both the left resilient portion 911A and right resilient portion 911B have a left leg 910 and a right leg 912 joined together at a front end 914 thereof and forms an inverted V-shaped contour viewed from a top side. In addition, the left leg 910 has a foot 9101 projects outwardly along a left direction, and the right leg 912 has a foot 9121 projects outwardly along a right direction.

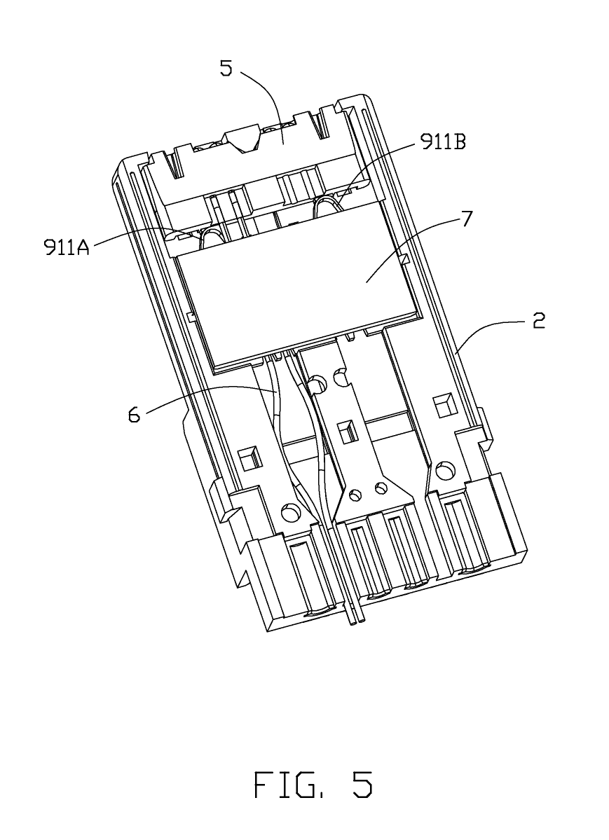

The resilient member 91 is mounted to the mounting cavity 221, with the feet 9101, 9121 abutting against the back side 2210 of the mounting cavity 221, the transversal beam 9102 is sandwiched between the protrusion 2214 and the back side 2210 of the mounting cavity 221. The optical module 5 is disposed in front of the resilient member 91, and the Page of front end 914 of either the right resilient portion 911A or the left resilient portion 911B positioned in concavity (not numbered) in a lateral segment of the holder member 52. The concavity is defined in a protruding tab 522 (FIG. 5) which projects backwardly from a back surface 520 of the holder member 52 to cooperate with the front end 914 of the resilient member 91. However, the concavity may be also defined in the back surface 520 of the holder member 52.

When a pushing force exerted onto the optical module 5 to press the two resilient portions 911A, 911B, and the left leg 910 of the of the left resilient portion 911A and the right leg 912 of the right resilient portion 911B expand along the horizontal direction, with the foot 9101 of the left leg 910 of the left resilient portion 911A and the foot 9121 of the right leg 912 of the right resilient portion 911B sliding along the back surface 2210 along an opposite direction. The foot 9121 of the right leg 912 of the left resilient portion 911A and the foot 9101 of the left leg 910 of the right resilient portion 911B are located at their original places, and the right leg 912 of the left resilient portion 911A rotates around the foot 9121 along counterclockwise direction, while the left leg 910 of the right resilient portion 911B around the foot 9101 along clockwise direction. When the pushing force is withdrawn, the resilient member 91 can bias/deflect the optical module 5 along the mounting cavity 221.

Four fibers 6 are separated into two groups and enter a rear section of the mounting cavity 221, through the fiber grooves 213 and are coupled to the four lens 51, respectively.

The cap member 7 is assembled into the depression 224, with the resilient member 91 and the fibers 6 disposed underneath a bottom surface thereof. Two crushable ribs 71 are formed at the bottom surface of the cap member 7 and inserted into positioning holes 2242 which are located in the depression 224.

The metal shell 8 comprises a first shield part 81 and a second shield part 82. The first shield part 81 includes a front tube-shaped mating frame 811, a rear U-shaped body section 812 connected to a bottom side and lateral sides of the mating frame 811. The mating frame 811 further has two windows 8112 defined in a top side thereof. The second shield part 82 includes an inverted U-shaped body section 822, and a cable holder member 823 attached to a top side of the body section 822.

The insulative housing 2 is assembled to the first shield part 81, with the tongue portion 22 enclosed in the mating frame 811, the cap member 7 arranged underneath the windows 811, and the base portion 21 is received in the body portion 812. The second shield part 82 is assembled to the first shield part 81, with body portions 822, 812 combined together. The cable assembly may have a hybrid cable which includes fibers 6 for transmitting optical signals and copper wires (not shown) for transmitting electrical signals. The copper wires are terminated to the first contacts 3 and the second contacts 4. The cable holder member 823 is crimped onto the cable to enhance mechanical interconnection.

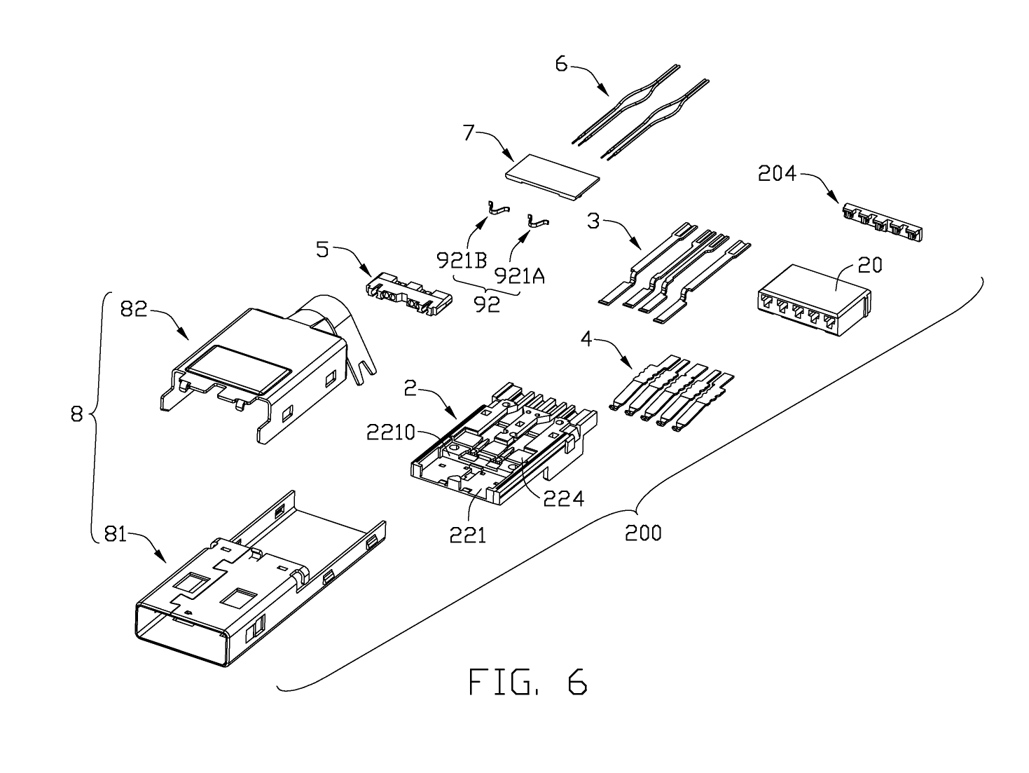

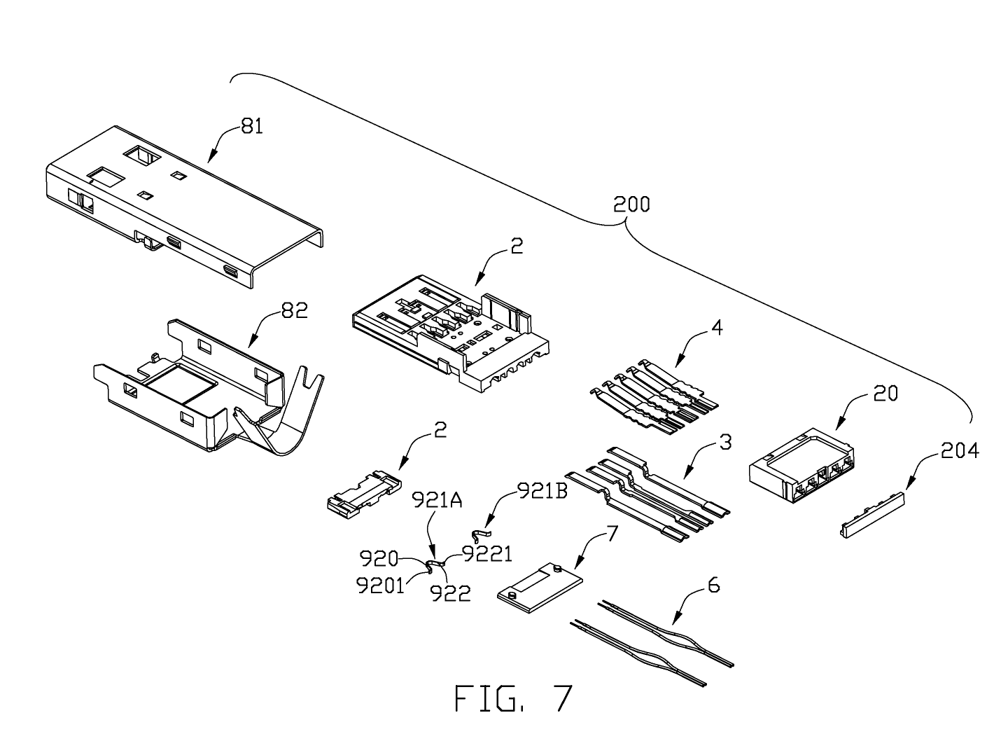

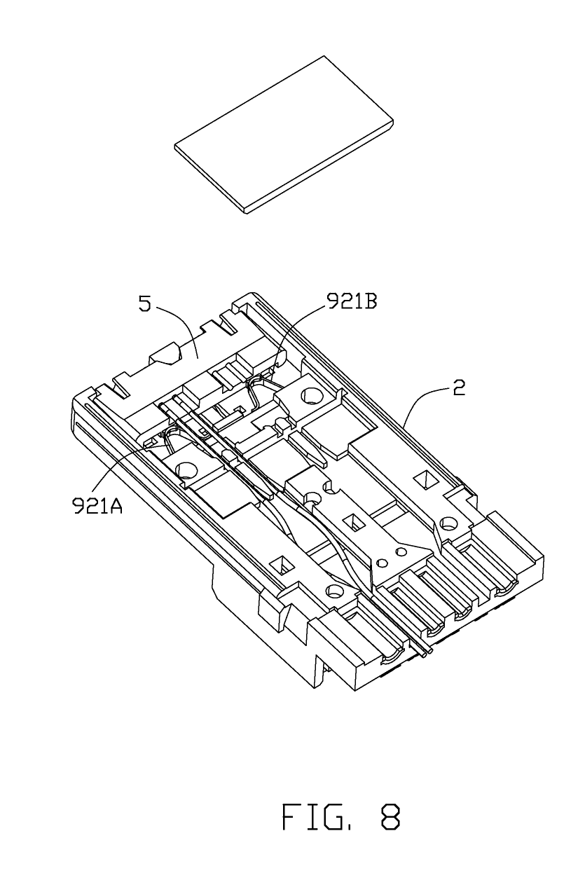

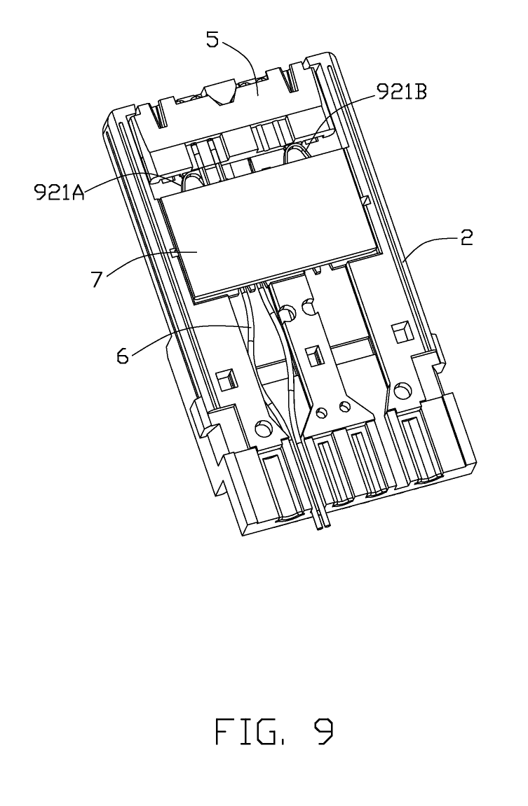

Referring to FIGS. 6-9, a cable assembly 200 in accordance with the second embodiment of the present invention is disclosed. The cable assembly 200 is similar to the cable assembly 100, excepted that a resilient member 92 has a left resilient portion 921A and a right resilient portion 921B which have identical contour. The left resilient portion 921A and the right resilient portion 921B are spaced apart from each other along the horizontal direction, but no media segment as the transversal beam 9102 in the first embodiment 100 to form physical interconnection between the left resilient portion 921A and the right resilient portion 921B. A cap member 7 is assembled to a depression 224 of the insulative housing 2 to cover the left resilient portion 921A and the right resilient portion 921B.

When the optical module 5 rearward movement to press the resilient member 92, a left leg 920 and a right leg 922 of the left resilient portion 921A expand along the horizontal direction, with a foot 9201 leftward sliding along a back 2210 of a mounting cavity 221, and a foot 9221 rightward sliding along the back 2210 of the mounting cavity 221. Also, the right resilient portion 921B moves in the mounting cavity 221 in same manner as the left resilient portion 921A does, detailed description is omitted hereby.

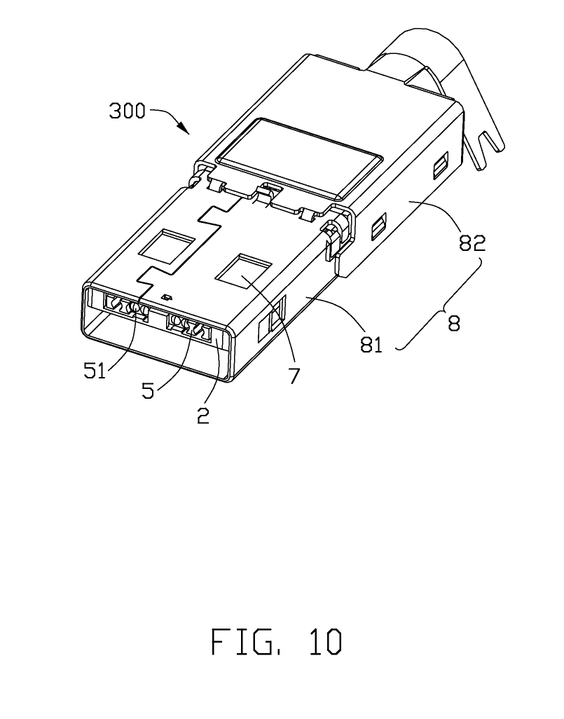

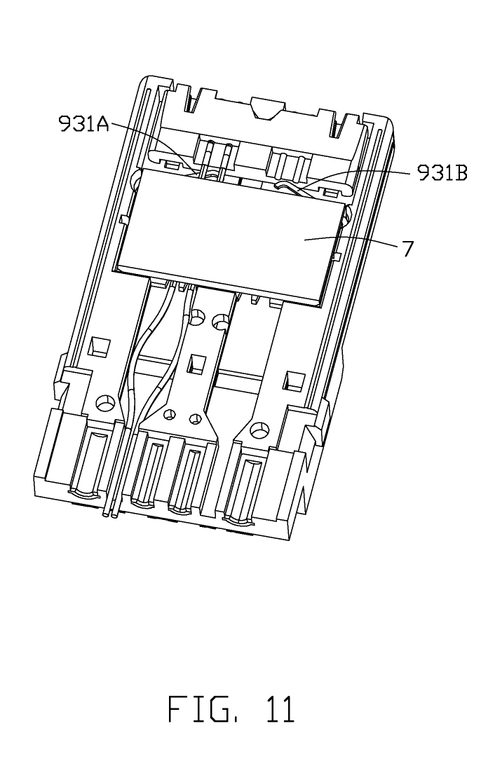

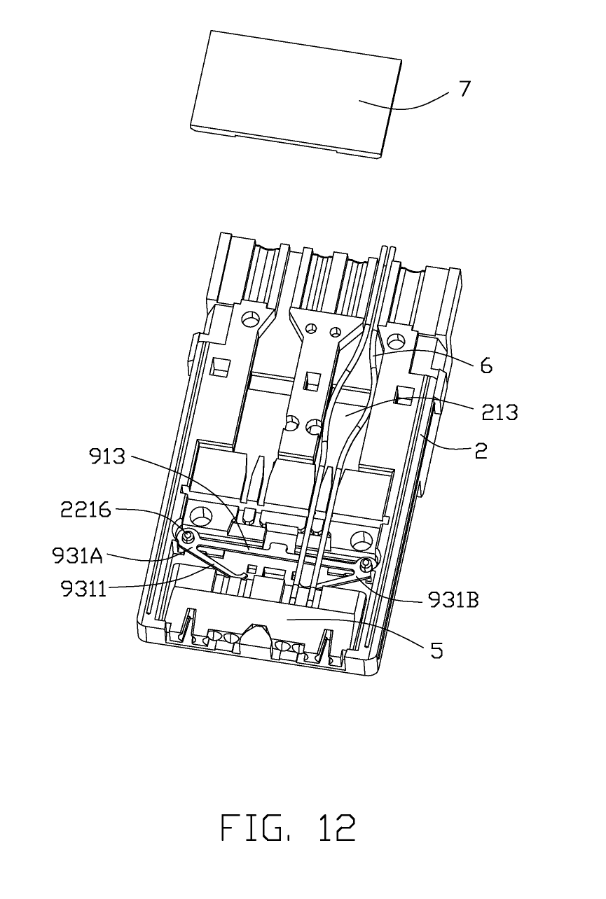

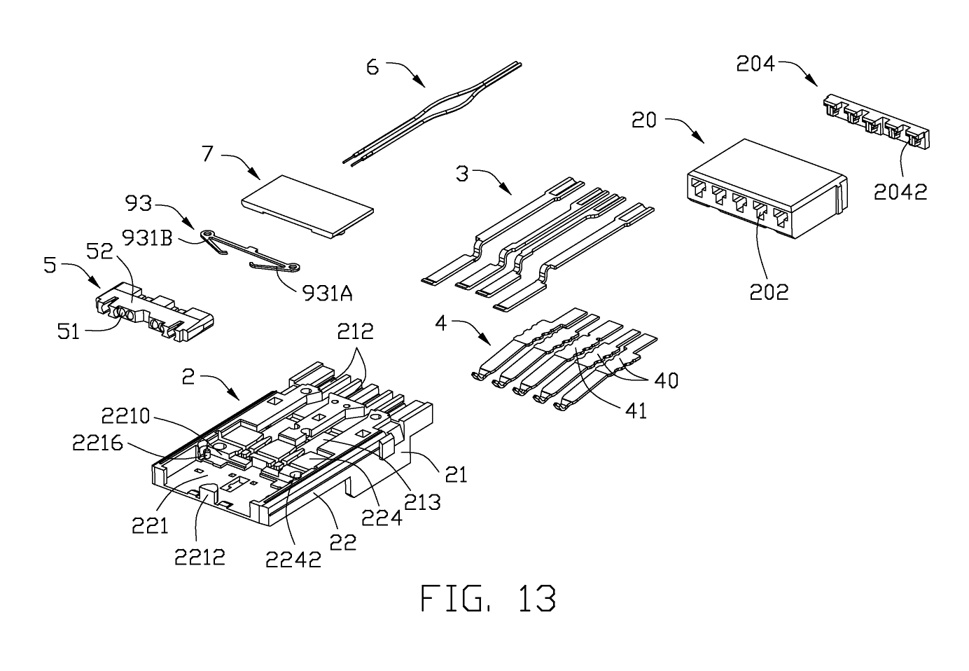

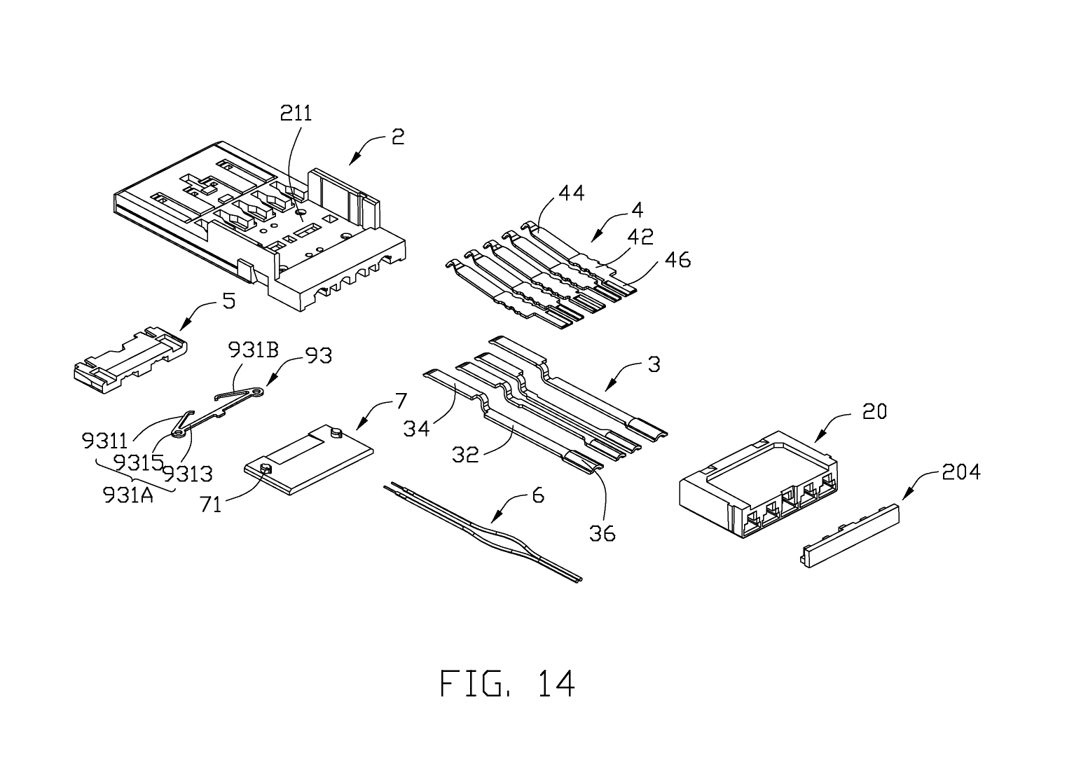

Referring to FIGS. 10-14, a cable assembly 300 in accordance with the third embodiment of the present invention is disclosed. The cable assembly 300 comprises an elongated insulative housing 2 extending along a front-to-back direction, a set of first contacts 3, a set of second contacts 4 and an optical modules 5 supported by the insulative housing 2, and a number of fibers 6 coupled to the optical module 5. The cable assembly 1 further comprises a cap member 7, a metal shell 8 and a resilient member 93. The resilient member 93 is capable of biasing the optical modular 5 along the front-to-back direction. Detail description of these elements and their relationship and other elements formed thereon will be detailed below.

The insulative housing 2 includes a base portion 21 and a tongue portion 22 extending forwardly from the base portion 21. A cavity 211 is recessed upwardly from a bottom surface (not numbered) of the base portion 21. A mounting cavity 221 is recessed downwardly from a top surface of the tongue portion 22. A stopping member 2212 is formed in the front portion of the mounting cavity 221. In addition, two positioning posts 2216 are located in a back portion of the mounting cavity 221. The two positioning posts 2216 are spaced apart from each other and arranged proximate to a back side 2210 of the mounting cavity 221. A depression 224 is defined in a rear portion of the tongue portion 22 and communicating with the mounting cavity 221. A number of contact slots 212 are defined in an upper segment of a rear portion of the base portion 21. Two fiber grooves 213 are defined in the base portion 21 and extend along the front-to-back direction, pass the depression 224 and communicate with the mounting cavity 221.

The set of first contacts 3 have four contact members arranged in a row along the transversal direction. Each first contact 3 substantially includes a planar retention portion 32 supported by a bottom surface of the cavity 211, a mating portion 34 raised upwardly and extending forwardly from the retention portion 32 and mounted into the lower section of the front segment of the tongue portion 22, and a tail portion 36 extending rearward from the retention portion 32 and accommodated in the terminal slots 212.

The set of second contacts 4 have five contact members arranged in a row along the transversal direction and combined with an insulator 20. The set of second contacts 4 are separated into two pairs of signal contacts 40 for transmitting differential signals and a grounding contact 41 disposed between the two pair of signal contacts 40. Each second contact 4 includes a planar retention portion 42 received in corresponding groove 202 in the insulator 20, a curved mating portion 44 extending forward from the retention portion 42 and disposed beyond a front surface of the insulator 20, and a tail portion 46 extending rearward from the retention portion 42 and disposed behind a back surface of the insulator 20. A spacer 204 is assembled to the insulator 20, with a number of ribs 2042 thereof inserted into the grooves 202 to position the second contacts 4 in the insulator 20.

The insulator 20 is mounted to the cavity 211 of the base portion 21 and press onto retention portions 32 of the first contacts 3, with mating portions 44 of the second contacts 4 located behind the mating portions 34 of the first contacts 3 and above the up surface of the tongue portion 22, the tail portions 46 of the second contacts 4 arranged on a bottom surface of the rear segment of the base portion 21 and disposed lower than the tail portions 36 of the first contacts 3.

The optical module 5 includes four lens members 51 arranged in juxtaposed manner and enclosed by a holder member 52 and retained in the mounting cavity 221.

The resilient member 93 is configured as a one-piece type structure and includes two substantially triangular shaped resilient portions which includes a left resilient portion 931A and a right resilient portion 931B connected with each other and arranged in juxtaposed manner. The left resilient portion 931A has a horizontal arm 9313 and deflected arm 9311 extending forwardly and inwardly from left end of the horizontal arm 9313. Furthermore, a positioning hole 9315 is defined in the left end of the horizontal arm 9313. The right resilient portion 931B has same structure as the left resilient portion 931A, but symmetrically arranged regarding to the left resilient portion 931A, and detailed description about itself is omitted hereby.

The resilient member 93 is mounted to the mounting cavity 221, with the horizontal arm 9313 abutting against the back side 2210 of the mounting cavity 221, and the positioning post 2216 inserted into the positioning hole 9315 to secure the resilient member 93. The optical module 5 is disposed in front of the resilient member 9, and a front end the deflected arm 9311 of the left resilient portion 931A pressing onto the optical module. The right resilient portion 931B is mounted to the mounting cavity 221 with same manner as the left resilient portion 931A, and detailed description is omitted hereby.

When a pushing force exerted onto the optical module 5 to press the left and right resilient portions 931A, 931B, and the deflected arm 9311 is compressed/pressed to move backwardly. When the pushing force is withdrawn, the deflected arm 9311 is restored so as to bias/deflect the optical module 5 along the mounting cavity 221.

The fibers 6 enter a rear section of the mounting cavity 221, through the fiber grooves 213 and are coupled to the lenses 51, respectively.

The cap member 7 is assembled into the depression 224, with the resilient member 93 and the fibers 6 disposed underneath a bottom surface thereof. Two crushable ribs 71 are formed at the bottom surface of the cap member 7 and inserted into positioning holes 2242 which are located in the depression 224.

The metal shell 8 comprises a first shield part 81 and a second shield part 82 which are combined together to shield the insulative housing 2 therein.

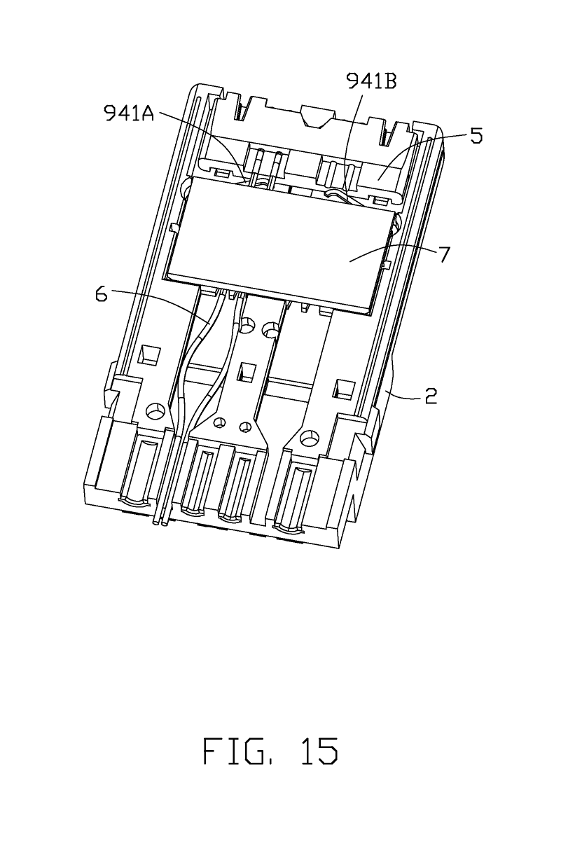

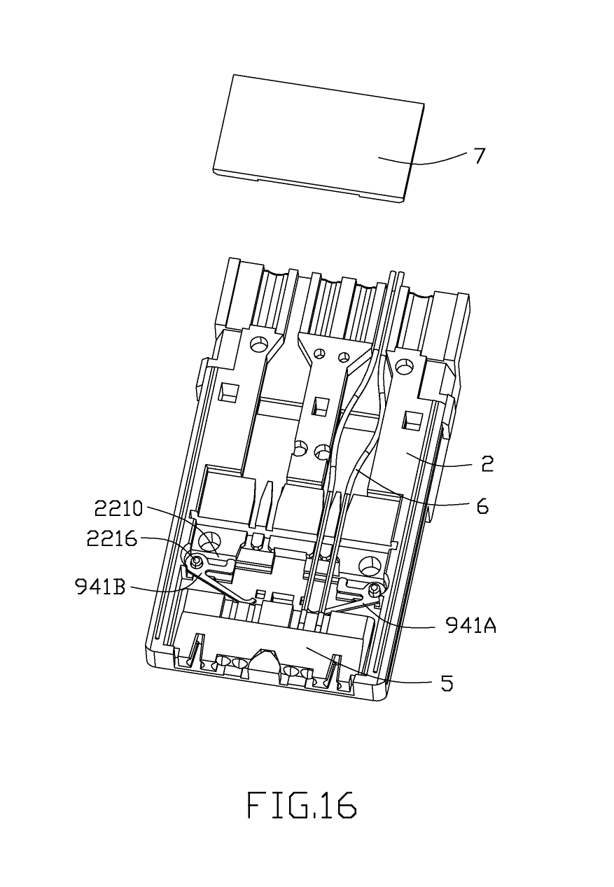

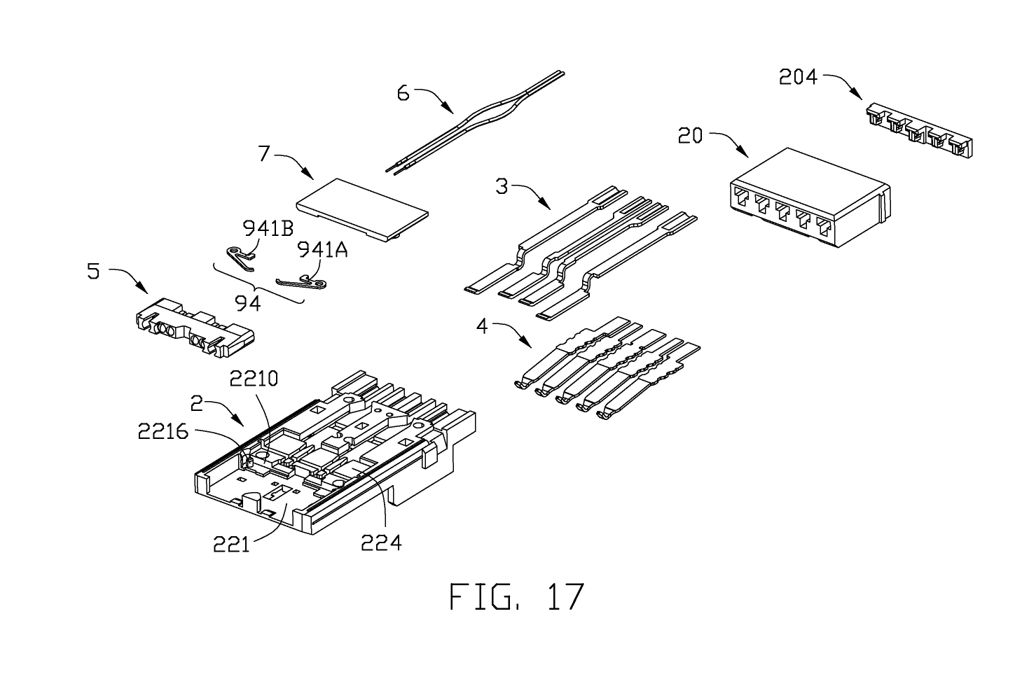

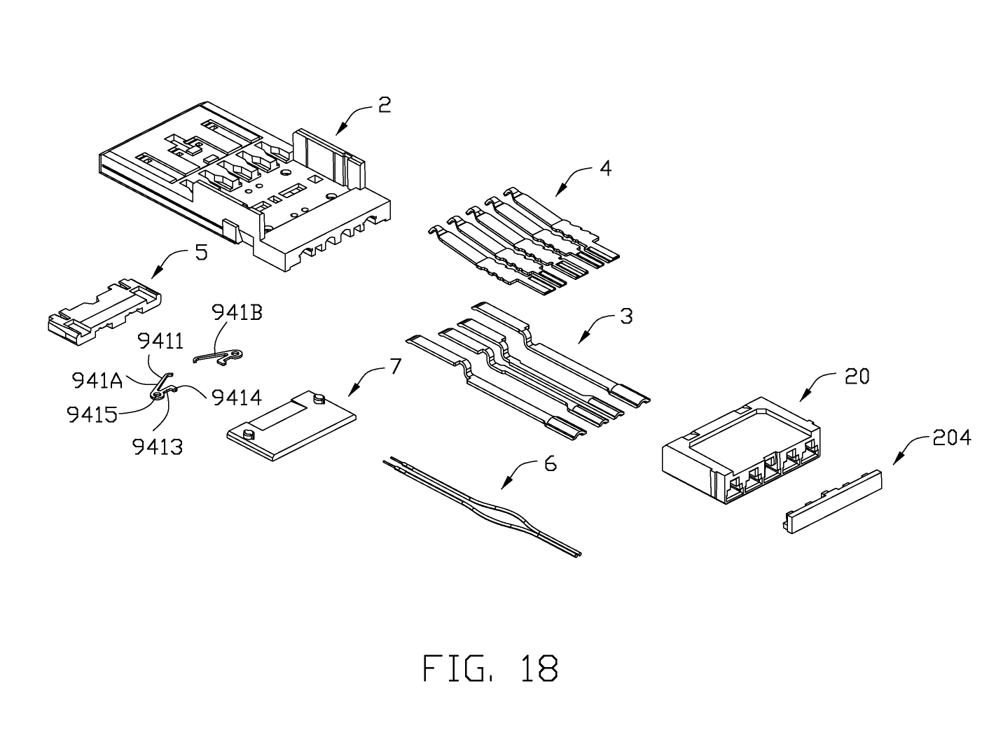

Referring to FIGS. 15-18, a cable assembly in accordance with the fourth embodiment of the present invention is disclosed. The cable assembly is similar to the cable assembly 300, excepted that a resilient member 94 has a left resilient portion 941A and a right resilient portion 941B which have identical contour. The left resilient portion 941A and the right resilient portion 941B are spaced apart from each other along the horizontal direction, but the left resilient portion 941A and the right resilient portion 941B are not connected with each other. The left resilient portion 941A has a horizontal arm 9413 and deflected arm 9411 extending forwardly and inwardly from left end of the horizontal arm 9413. Furthermore, a positioning hole 9415 is defined in the left end of the horizontal arm 9413, and a protrusion 9414 is formed at the right end (free end) of the horizontal arm 9413 and projects backwardly. The left resilient portion 941A is mounted to a left segment of the mounting cavity 221, with the positioning post 2216 inserted into the positioning hole 9415, the deflected arm 9411 pressing onto the optical module 5, the protrusion 9414 pressing onto the back side 2210 of the mounting cavity 221. The right resilient portion 941B is assembled to a right segment the mounting cavity 221, with same manner as the left resilient portion 941A is done, and detailed description is omitted hereby. A cap member 7 is assembled to a depression 224 of the insulative housing 2 to cover the left resilient portion 941A and the right resilient portion 941B.

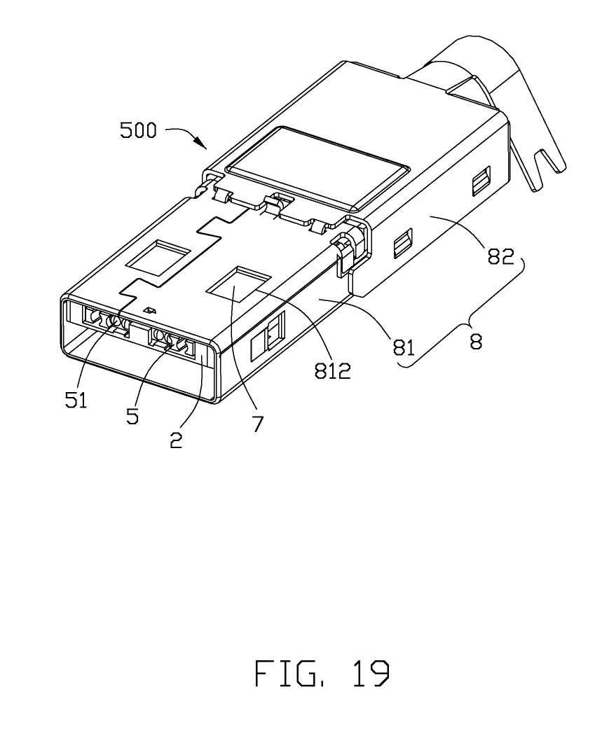

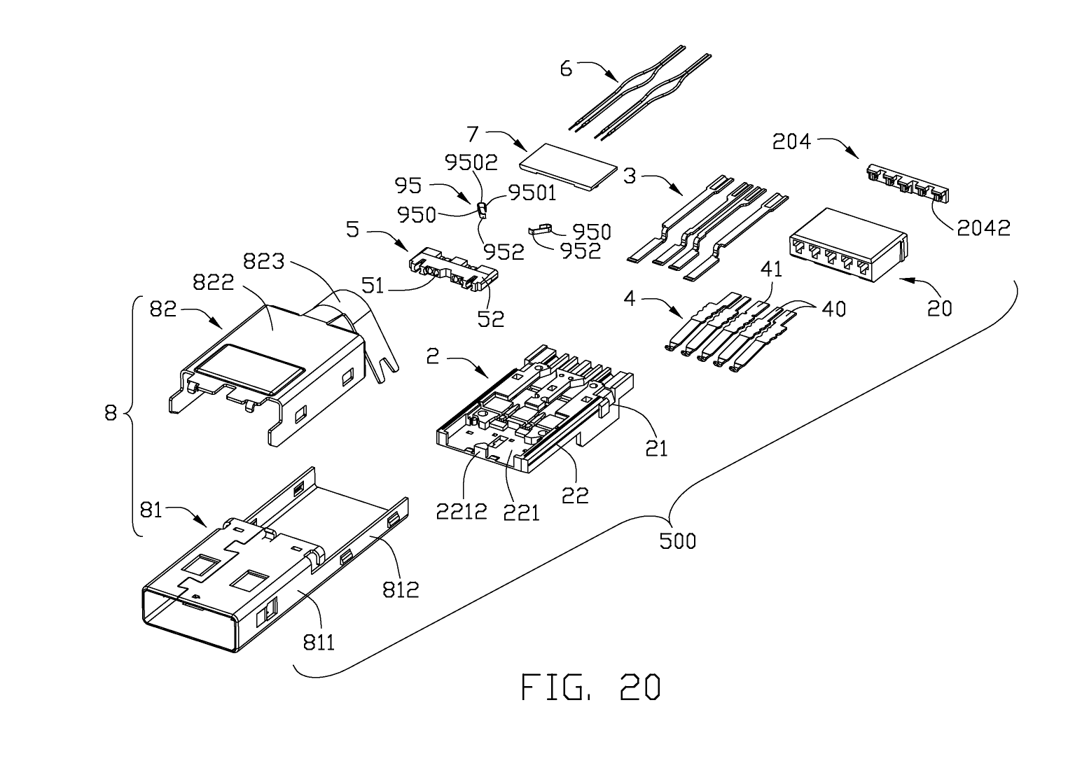

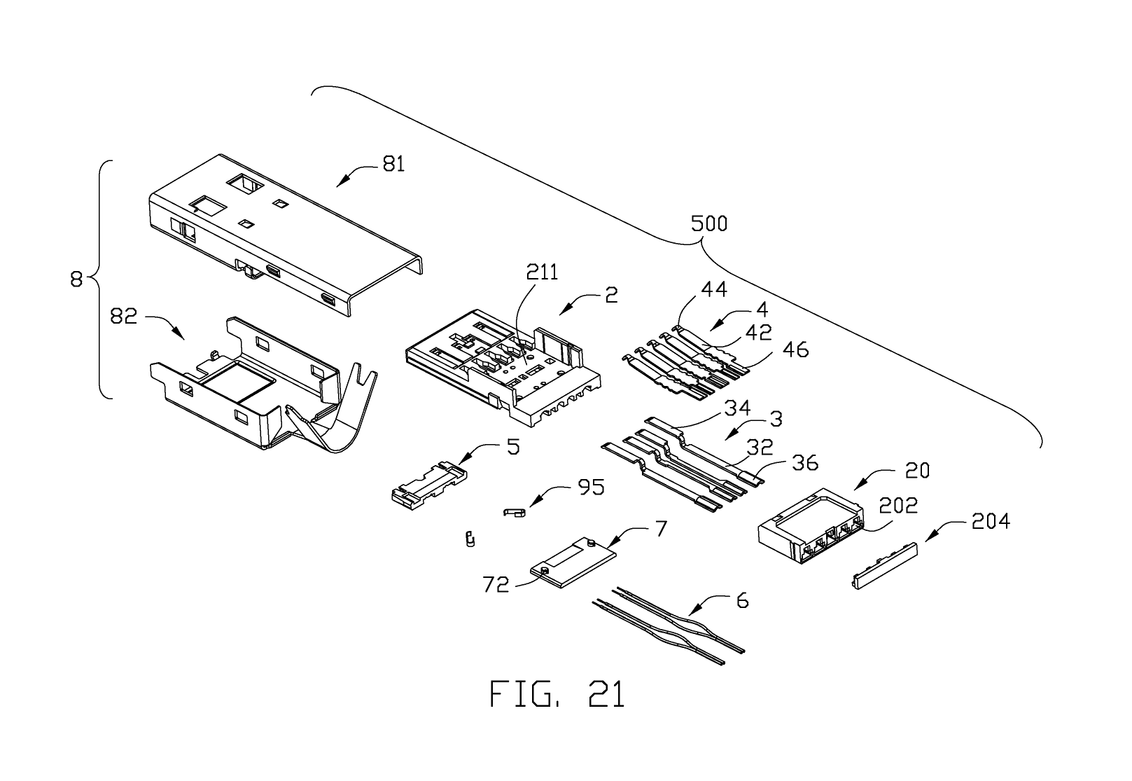

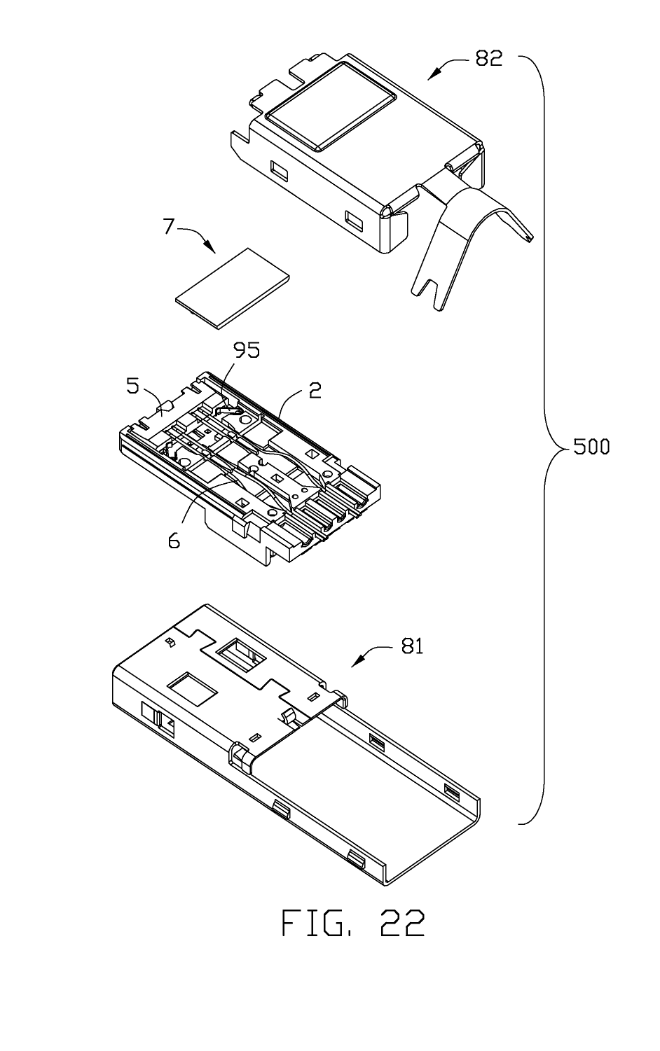

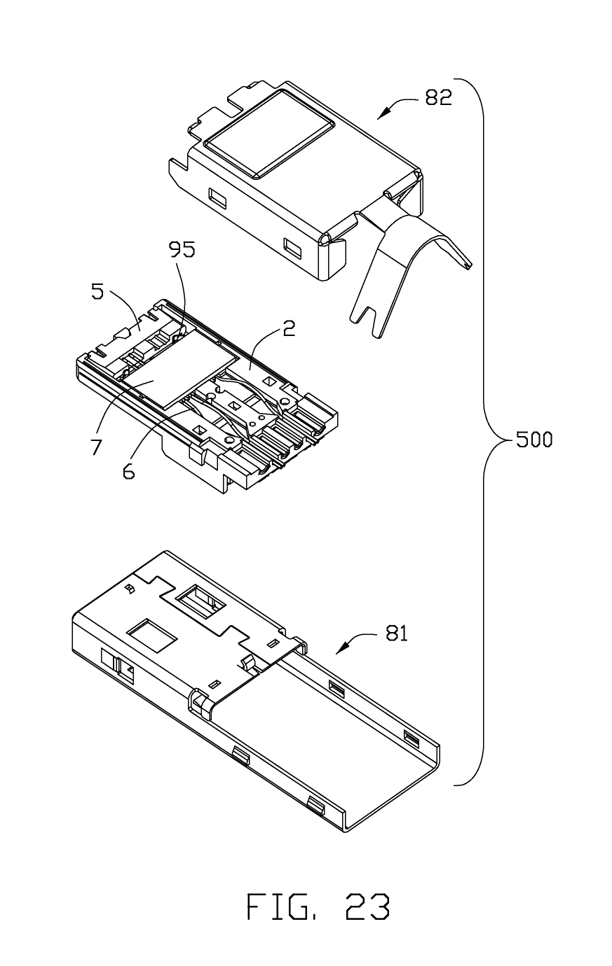

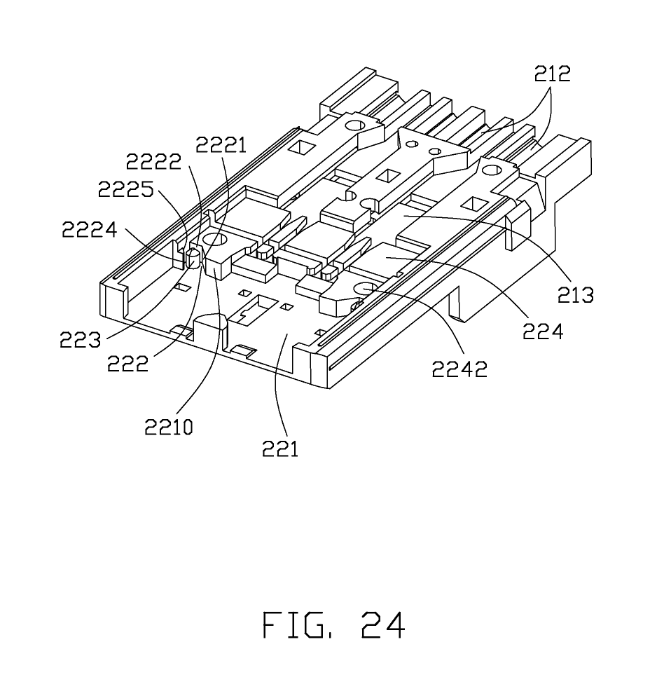

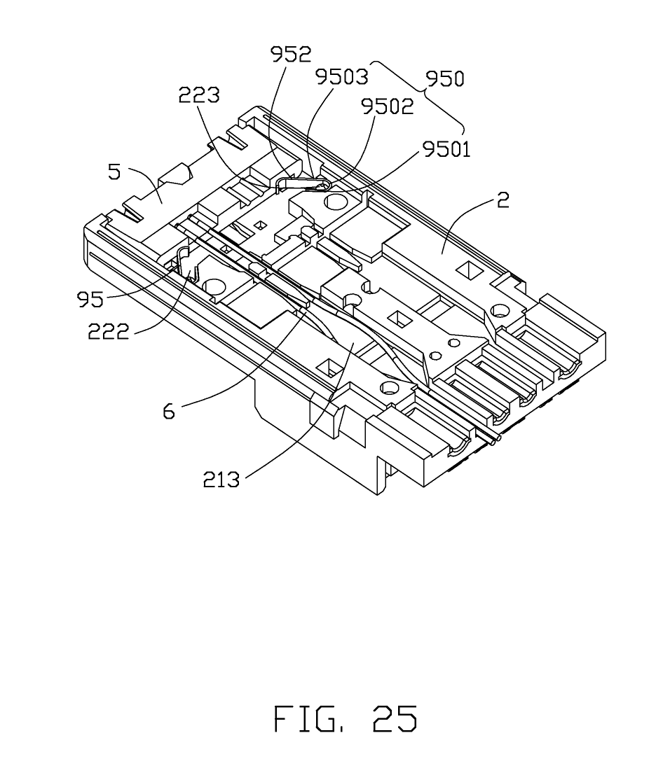

Referring to FIGS. 19-25, a cable assembly 500 in accordance with the fifth embodiment the present invention is disclosed. The cable assembly 500 comprises an elongated insulative housing 2 extending along a front-to-back direction, a set of first contacts 3, a set of second contacts 4 and an optical modules 5 supported by the insulative housing 2, and a number of fibers 6 coupled to the optical module 5. The cable assembly 1 further comprises a cap member 7, a metal shell 8 and two resilient members 95 spaced apart from each other along a transversal direction which is perpendicular to the front-to-back direction. The resilient members 95 are capable of biasing the optical modular 5 along the front-to-back direction. Detail description of these elements and their relationship and other elements formed thereon will be detailed below.

The insulative housing 2 includes a base portion 21 and a tongue portion 22 extending forwardly from the base portion 21. A cavity 211 is recessed upwardly from a bottom surface (not numbered) of the base portion 21. A mounting cavity 221 is recessed downwardly from a top surface of the tongue portion 22. A stopping member 2212 is formed in a front portion of the mounting cavity 221. A pair of positioning slots 222 are defined in lateral sides of the tongue portion 22 and located behind and communicating with the mounting cavity 221. Each positioning slot 222 has a first inner side 2221 oblique to a front-to-back direction (or longitudinal direction), a second inner side 2222 perpendicular to the front-to-back direction. A protruding portion 2224 projects into the each positioning slot 222, and the protruding portion 2224 has an inner surface 2225 parallel with the first inner side 2221. Therefore, the each positioning slot 222 is obliquely opened toward and communicated with the mounting cavity 221. Furthermore, a positioning post 223 is located in the positioning slot 222, with a groove (not numbered) is formed between a peripheral of the positioning post 223 and the first inner side 2221, the second inner side 2222 and the inner surface 2225. A depression 224 is defined in a rear portion of the tongue portion 22 and communicating with the mounting cavity 221. The positioning slots 222 and the protruding portions 2224 are disposed underneath the depression 224. A number of contact slots 212 are defined in an upper segment of a rear portion of the base portion 21. Two fiber grooves 213 are defined in the base portion 21 and extend along the front-to-back direction, pass the depression 224 and communicate with the mounting cavity 221.

The set of first contacts 3 have four contact members arranged in a row along the transversal direction. Each first contact 3 substantially includes a planar retention portion 32 supported by a bottom surface of the cavity 211, a mating portion 34 raised upwardly and extending forwardly from the retention portion 32 and disposed in a depression 226 of the lower section of the front segment of the tongue portion 22, and a tail portion 36 extending rearward from the retention portion 32 and accommodated in the terminal slots 212.

The set of second contacts 4 have five contact members arranged in a row along the transversal direction and combined with an insulator 20. The set of second contacts 4 are separated into two pairs of signal contacts 40 for transmitting differential signals and a grounding contact 41 disposed between the two pair of signal contacts 40. Each contact 4 includes a planar retention portion 42 received in corresponding groove 202 in the insulator 20, a curved mating portion 44 extending forward from the retention portion 42 and disposed beyond a front surface of the insulator 20, and a tail portion 46 extending rearward from the retention portion 42 and disposed behind a back surface of the insulator 20. A spacer 204 is assembled to the insulator 20, with a number of ribs 2042 thereof inserted into the grooves 202 to position the second contacts 4 in the insulator 20.

The insulator 20 is mounted to the cavity 211 of the base portion 21 and press onto retention portions 32 of the first contacts 3, with mating portions 44 of the second contacts 4 located behind the mating portions 34 of the first contacts 3 and above the up surface of the tongue portion 22, the tail portions 46 of the second contacts 4 arranged on a bottom surface of the rear segment of the base portion 21 and disposed lower than the tail portions 36 of the first contacts 3.

The optical module 5 includes four lens members 51 arranged in juxtaposed manner and enclosed by a holder member 52. The optical module 5 is accommodated in the mounting cavity 221 and capable of moving therein along the front-to-back direction.

The two resilient members 95 are made of metallic material with good resilient performance. Each resilient member 95 has a U-shaped mounting portion 950 and a deflectable arm 952 extending from the mounting portion 950. The mounting portion 950 has a first mounting arm 9501, a second mounting arm 9503 and a connecting portion 9502 connecting with ends of the first mounting arm 9501 and the second mounting arm 9503. The first mounting arm 9501 and the second mounting arm 9503 are parallel to each other. The deflectable arm 952 extends forwardly from the second mounting arm 9503.

Each resilient member 95 is mounted to the insulative housing 2, with the mounting portion 950 accommodated in the corresponding positioning slot 222 and the deflectable arm 952 obliquely projecting into the mounting cavity 221 to press onto the optical module 5. The positioning post 223 extends into and engages with the mounting portion 950. The first mounting arm 9501 rides against the first inner side 2221 of the positioning slot 222, the second mounting arm 9503 abuts against the inner surface 2225 of the protruding portion 2224, and the connecting portion 9502 abuts against the second inner side 2222 of the positioning slot 222. Therefore, the resilient member 95 is reliably retained in the positioning slot 222.

Four fibers 6 enter a rear section of the mounting cavity 221, through the fiber grooves 213 and are coupled to the four lens 51, respectively.

The cap member 7 is assembled into the depression 224 and covers the positioning slots 222. The cap member 7 has two crushable ribs 72 formed on a bottom surface thereof and are inserted into positioning holes 2242 which are defined in the depression 224. Therefore the fibers 6 are confined in the fiber grooves 213, and they are unable to drift freely in the mounting cavity 221. Furthermore, the mounting portions 950 of the resilient members 95 are also shielded by the cap member 7.

The metal shell 8 comprises a first shield part 81 and a second shield part 82. The first shield part 81 includes a front tube-shaped mating frame 811, a rear U-shaped body section 812 connected to a bottom side and lateral sides of the mating frame 811. The mating frame 811 further has two windows 8112 defined in a top side thereof. The second shield part 82 includes an inverted U-shaped body section 822, and a cable holder member 823 attached to a top side of the body section 822.

The insulative housing 2 is assembled to the first shield part 81, with the tongue portion 22 enclosed in the mating frame 811, the cap member 7 arranged underneath the windows 811, and the base portion 21 is received in the body portion 812. The second shield part 82 is assembled to the first shield part 81, with body portions 822, 812 combined together. The cable assembly may have a hybrid cable which includes fibers 6 for transmitting optical signals and copper wires (not shown) for transmitting electrical signals. The copper wires are terminated to the first contacts 3 and the second contacts 4. The cable holder member 823 is crimped onto the cable to enhance mechanical interconnection.

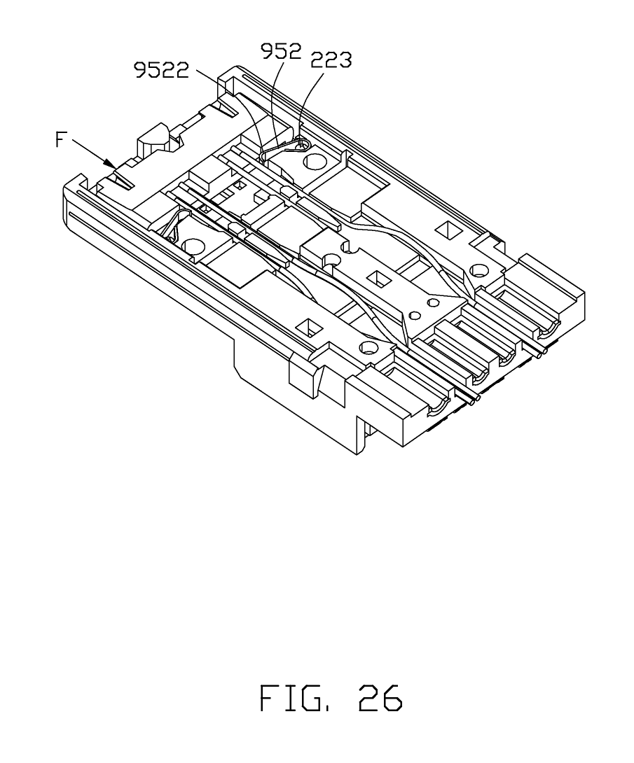

Referring to FIG. 26 in conjunction with FIGS. 19-25, when the cable assembly 500 plugs into/mates with a receptacle connector (not shown), and the optical module 5 moves backwardly by reverse pushing force F exerted by its counterpart (not shown), and the optical module 5 pushes the deflectable arms 952 to rotate around the positioning post 223 and free ends 9522 of the deflectable arms 952 moves towards a back surface 2210 of the mounting cavity 221. When the force F withdraws, the deflectable arms 952 can bias/deflect the optical module 5 forwardly movement along the mounting cavity 221. As the two resilient members 9 are spaced apart from each other along the transversal direction, therefore they can provide a balanced force onto the optical module 5, and no tilting problem occurs during the optical module 5 moving along the mounting cavity 221.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

What is claimed is:

1. A cable assembly, comprising:
an insulative housing defining a mounting cavity;
an optical module accommodated in the mounting cavity and capable of moving therein along a front-to-back direction;
at least one fiber coupled to the optical module; and
a one-piece resilient member disposed in the mounting cavity and arranged behind the optical module, the resilient member having a left resilient portion and a right resilient portion spaced apart from each other along a transversal direction to bias the optical module.

2. The cable assembly as claimed in claim 1, wherein the resilient member has a transversal beam connected the left resilient portion and the right resilient portion together.

3. The cable assembly as claimed in claim 2, wherein a protrusion is located in the mounting cavity and arranged proximate to a back side of the mounting cavity, and the transversal beam is sandwiched between the protrusion and the back side of the mounting cavity.

4. The cable assembly as claimed in claim 1, wherein either the left resilient portion or the right resilient portion is substantially bell-shaped from a top side view perspective.

5. The cable assembly as claimed in claim 4, wherein either the left resilient portion or the right resilient portion has a left leg and a right leg joined together at a front end thereof.

6. The cable assembly as claimed in claim 1, wherein the left resilient portion and the right resilient portion are of triangular shape.

7. The cable assembly as claimed in claim 6, wherein the left resilient portion includes a horizontal arm and a deflected arm extending forwardly and inwardly from a left end of the horizontal arm.

8. The cable assembly as claimed in claim 7, wherein the deflected arm presses onto the optical module.

9. The cable assembly as claimed in claim 7, wherein the horizontal arm is disposed adjacent to a back side of the mounting cavity.

10. The cable assembly as claimed in claim 7, wherein a positioning hole is defined in a left end of the horizontal arm, and a positioning post is formed in the mounting cavity and inserted into the positioning hole.

11. A cable assembly, comprising:
an insulative housing defining a mounting cavity and two positioning slots spaced apart from each other along a transversal direction and located behind the mounting cavity, each positioning slot obliquely opened towards and communicated with the mounting cavity;
an optical module accommodated in the mounting cavity and capable of moving therein along a front-to-back direction;
at least one fiber coupled to the optical module; and
two resilient members mounted to the insulative housing, each resilient member having a mounting portion accommodated in the corresponding positioning slot and a deflectable arm extending into the mounting cavity to bias the optical module.

12. The cable assembly as claimed in claim 11, wherein a positioning post is located in the positioning slot and engages with the mounting portion of the resilient member.

13. The cable assembly as claimed in claim 12, wherein the mounting portion of the resilient member has a U-shaped contour and the positioning post projects into the mounting portion.

14. The cable assembly as claimed in claim 12, wherein each positioning slot has a first inner side oblique to the front-to-back direction, and the mounting portion has a first mounting arm rides against the first inner side.

15. The cable assembly as claimed in claim 13, wherein a respective protruding portion projects into each positioning slot, and the mounting portion has a second mounting arm abuts against an inner surface of the protruding portion.

16. The cable assembly as claimed in claim 15, wherein the first inner side of the positioning slot is parallel to the inner surface of the protruding portion.

17. The cable assembly as claimed in claim 15, wherein each positioning slot has a second inner side perpendicular to the front-to-back direction, and the mounting portion has a connecting portion connected with the first and second mounting arms and abuts against the second inner side.

18. A cable connector assembly comprising:
an insulative housing defining an electrical mating port and an optical mating port at different first and second levels;
a mounting cavity formed at the second level;
an optical module disposed in the mounting cavity; and
a resilient urging device essentially locate around the mounting cavity with a securing section fastened to the housing and with a pair of engaging points forwardly abutting against a rear side of the optical module; wherein
the contacting points are symmetrically arranged with each other relative to a center line of the optical module, and a distance between said pair of contacting points is not less than one third of a transverse dimension of the optical module.

19. The cable connector assembly as claimed in clam 18, wherein said urging device essentially consists of two parts each defining the corresponding contacting point.
